(19) United States
(12) Patent Application Publication
(10) Pub. No.: US 2008/0283012 A1
(43) Pub. Date: Nov. 20, 2008

(54) Parallel Starting System Having a Low Wiring Expenditure

(76) Inventor: Hartmut Wanner, Herrenberg-Oberjesingen (DE)

Correspondence Address: KENYON & KENYON LLP, ONE BROADWAY, NEW YORK, NY, 10004, US

(21) Appl. No.: 11/883,693

(22) PCT Filed: Dec. 14, 2005
(86) PCT No.: PCT/EP2005/056787

§ 371 Date: Apr. 24, 2008

(30) Foreign Application Priority Data
Feb. 11, 2005 (DE) 10 2005 006 248.2

(51) Int. Cl. F02N 11/08

(52) U.S. Cl. 123/179.25; 290/38 R

(57) ABSTRACT

A starter system for starting internal combustion engines including a plurality of starters connected in parallel, each having a starter motor and an engaging relay. This parallel starting system may be implemented simply and cost-effectively if at least one of the starters includes a power relay which switches the primary current path to the associated starter motor, and the engaging relay, the power relay, and the starter motor are implemented as a structural unit.

### FIELD OF THE INVENTION

The present invention relates to a parallel starting system for starting internal combustion engines.

### BACKGROUND INFORMATION

Normally, electrically operated starters are used for starting internal combustion engines. In large engines having several tens or hundreds of liters of displacement such as, for example, marine engines, it is known to connect a plurality of starters in parallel to be able to provide the high starter power.

FIG. 1 shows a parallel starting system from the related art having two starters 1a, 1b. Each of the starters includes a starter motor 2a, 2b and an engaging relay 4a, 4b which normally performs two functions. On the one hand, engaging relay 4a, 4b engages a pinion (not shown) driven by starter motor 2a, 2b with a ring gear of the internal combustion engine. On the other hand, engaging relay 4a, 4b closes a primary current path 8 via a normally open contact 5a, 5b when the pinion has engaged with the ring gear. This begins the actual starting operation.

To prevent one of the two starters 1a, 1b from beginning the starting operation earlier than the other, both starters 1a, 1b are interconnected in such a way that primary current path 8 to starter motors 2a, 2b is not closed until both pinions are engaged or both engaging relays 4a, 4b have completely pulled up. The two engaging relays 4a, 4b are in this case connected in parallel with respect to their control terminal and are connected to a terminal 50 which is connected to the starter switch (switch 6). The load terminals (terminals 30, 30b) of engaging relays 4a, 4b are, however, interconnected in series. Terminal 30 of first starter 1a is connected to a battery which supplies it a voltage U+.

In a starting operation, i.e., after ignition 6 is activated, windings HW (holding winding) and EW (pull-in winding) of engaging relays 4a, 4b are supplied with current. As a result, both engaging relays 4a, 4b pull in, switches 5a, 5b being closed. When both switches 5a, 5b are closed, both starter motors 2a, 2b are supplied with current simultaneously and start the internal combustion engine. It is a disadvantage in this case that both engaging relays 4a, 4b must switch and conduct the same current for both starter motors 2a, 2b. Noise-contaminated actuating signals (signal bounce) can therefore result in high contact erosion and a high risk of contact welding exists.

### SUMMARY OF THE INVENTION

An object of the present invention is therefore to improve the switching reliability. A further object of the present invention is to develop a parallel starting system that can be wired using minimum complexity. This object is achieved according to the present invention.

An important idea of the present invention is to separate the customary concatenation of the functions “engage” and “switch primary current” of conventional engaging relays and instead provide two relays, one of which (engaging relay) performs the function “engage” and the other (power relay) exclusively performs the function “switch primary current.” The engaging relay and the power relay are preferably designed as a structural unit together with the associated starter motor. This makes it possible to devise a parallel starting system that may be wired in a simple and low-cost manner and in which the power relay need not be designed for excessively high loads.

The starters are preferably interconnected in such a way that the power relays do not switch the primary current to the starter motors until all engaging relays have pulled up (i.e., all pinions have engaged or the engaging springs are under tension).

According to a first embodiment (FIG. 2) of the present invention, the engaging relays of two starters are connected with one another in series. This means the control terminal of the subsequent engaging relay is connected to the load terminal of the preceding engaging relay. The load terminals of the engaging relays are preferably connected to terminal 30. If the engaging relays are connected in series, relatively high current flows to the second engaging relay, making a relatively thick connecting cable between the starters necessary.

According to a second embodiment (FIG. 4) of the present invention, the engaging relays of two starters are connected in parallel with respect to their control terminals. The load terminals of the engaging relays are preferably connected in series, the first load terminal preferably being connected to terminal 30. The load terminal of the last engaging relay is preferably interconnected with the control terminal (50k) of a power relay. The power relays are preferably connected in parallel. The advantage of the series connection of the load terminals is that the flow of current between two starters is substantially lower.

According to a preferred embodiment of the present invention, each of the starters has its own power relay which switches the flow of current to the starter motor. Optionally, at least one of the starters may also not have its own power relay (FIG. 5). In this case, this engaging relay performs both functions, namely “engage” and “switch primary current.”

Preferably, a three-pole connection is provided between two starters connected in parallel. If the connecting cable of a starter has a plug connection, it is possible to connect a plurality of starters in a simple manner. When wiring the starters, it is only necessary to take note of the position of the starter in question in the chain of starters.

### BRIEF DESCRIPTION OF THE DRAWINGS

FIG. 1 shows the electrical circuit diagram of a parallel starting system known from the related art.

FIG. 2 shows the circuit diagram of a parallel starting system according to a first embodiment of the present invention.

FIG. 3 shows the structural design of a parallel starting system according to FIG. 2.

FIG. 4 shows the circuit diagram of a parallel starting system according to a second embodiment of the present invention.

FIG. 5 shows the circuit diagram of a parallel starting system according to a third embodiment of the present invention.

FIGS. 6a and 6b show the circuit diagram of a parallel starting system having three starters.

### DETAILED DESCRIPTION

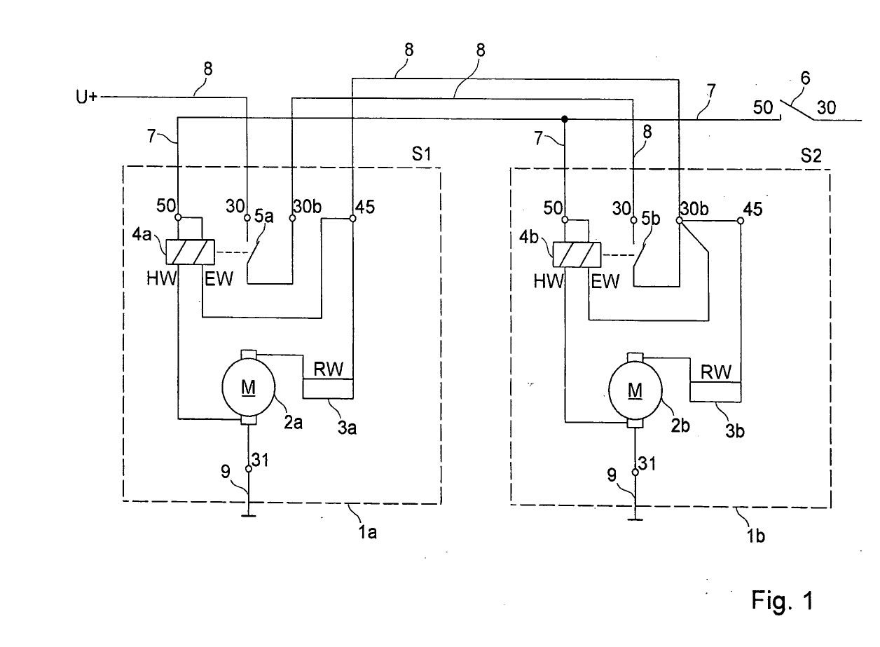

With respect to the explanation of FIG. 1, reference is made to the introduction of the background information.

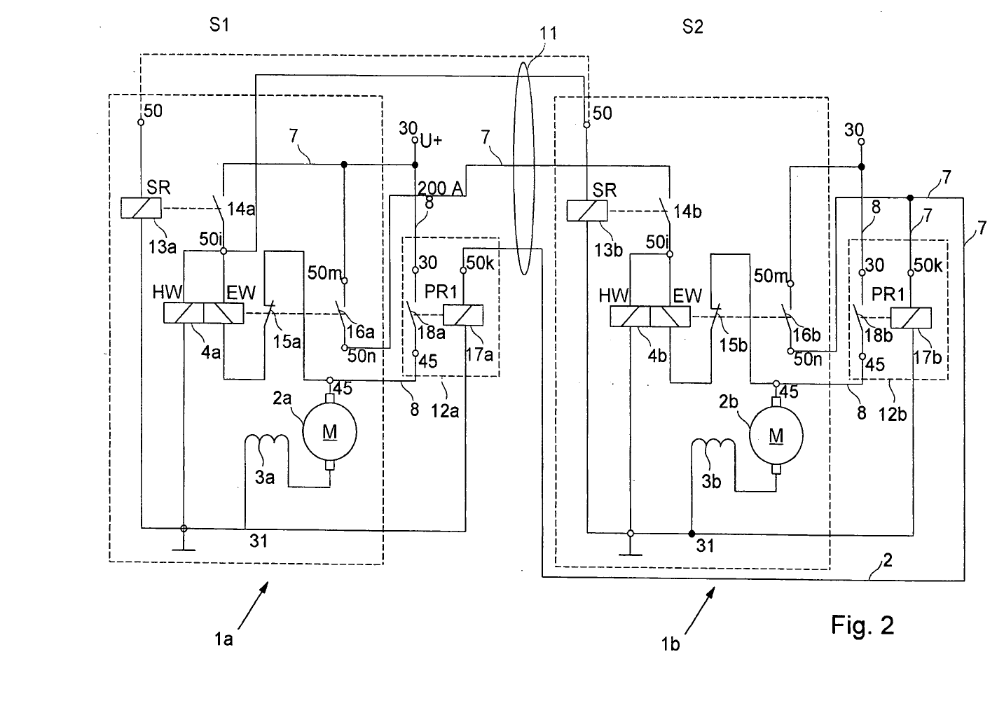

FIG. 2 shows a parallel starting system having two starters 1a, 1b. Each of starters 1a, 1b has a starting relay 13a, 13b, an engaging relay 4a, 4b, a power relay 12a, 12b and a starter motor 2a, 2b. The primary current of starter motors 2a, 2b is switched by power relays 12a, 12b. Engaging relays 4a, 4b are used only for engaging the pinion (not shown) with the ring gear and providing the starting current.

In a starting operation, starting relays 13a, 13b, which are connected in parallel and connected to terminal 50, pull in simultaneously and close associated switches 14a, 14b. This closes a current path 7 between terminal 30 and terminal 50i and current is supplied to the control terminal of both engaging relays 4a, 4b. In this case, engaging relays 4a, 4b are connected in series, i.e., the control terminal of engaging relay 4b is connected with the load terminal (terminal 50n) of engaging relay 4a. Therefore, switch 16a of first engaging relay 4a closes first and after that, switch 16b of second engaging relay 4b closes. The load terminals (terminal 50m) of the two engaging relays 4a, 4b are connected to terminal 30.

The load terminal (terminal 50n) of second engaging relay 4b is interconnected with the control terminals (terminal 50k) of power relays 12a, 12b. Closing second switch 16b therefore causes current to be supplied to the control terminals of power relays 12a, 12b. Power relays 12a, 12b are connected in parallel in this case. As a result, both associated switches 18a, 18b close approximately simultaneously and close the current path 8 between terminal 30 and terminal 45 of starter motors 2a and 2b, respectively. The internal combustion engine (not shown) is thus started approximately simultaneously by both starter motors 2a, 2b.

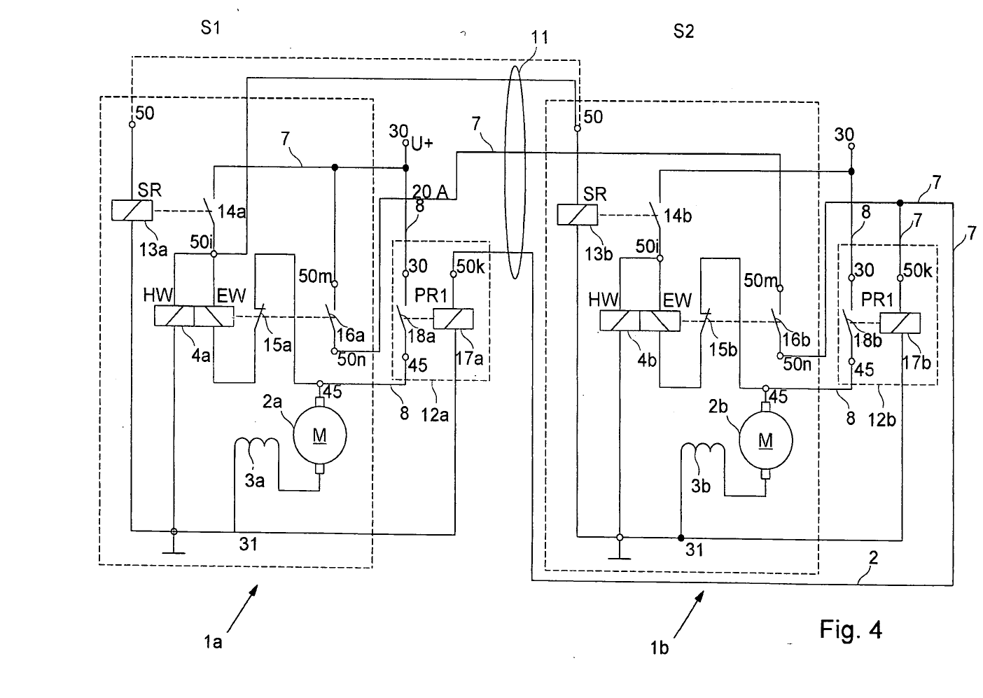

The two starters 1a, 1b in this case are connected with one another by a three-pole electrical line 11. A relatively high current of, e.g., 200 A, which is necessary for actuating relay 4b, flows between terminal 50n and 50i via control line 7. In the parallel starting system shown in FIG. 4, this current is substantially reduced, making it possible to use a thinner cable.

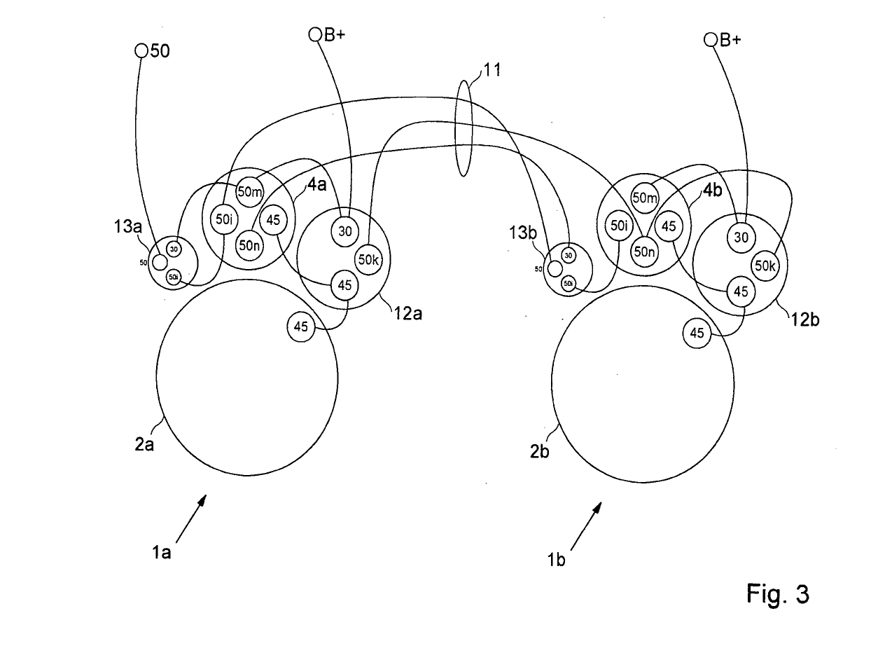

FIG. 3 shows the physical configuration of the parallel starting system of FIG. 2. Each of starters 1a, 1b is designed as a structural unit, having a starter motor 2a, 2b, a starting relay 13a, 13b, an engaging relay 4, and a power relay 12a, 12b. Starters 1a, 1b in this case are connected with one another via a three-pole electrical lead 11.

FIG. 4 shows a parallel starting system having two starters 1a, 1b that essentially have the same configuration as the starters of FIG. 2. With respect to the explanation of the individual elements and their mode of functioning, reference is therefore made to the description regarding FIG. 2. In contrast to the system of FIG. 2, the load terminals (terminals 50m, 50n) of engaging relays 4a, 4b are interconnected in series. As a result, only a substantially lower control current of approximately 20 A flows in control line 7 between terminals 50n and 50m, making it possible to use a substantially thinner line.

Load switch 18b of engaging relay 4b is in turn connected to terminals 50k of power relays 12a, 12b, which are connected in parallel. The control terminals (terminal 50i) of engaging relays 4a, 4b are connected in parallel and each of them is connected to terminal 30 via load contact 14a, 14b of the starting relays.

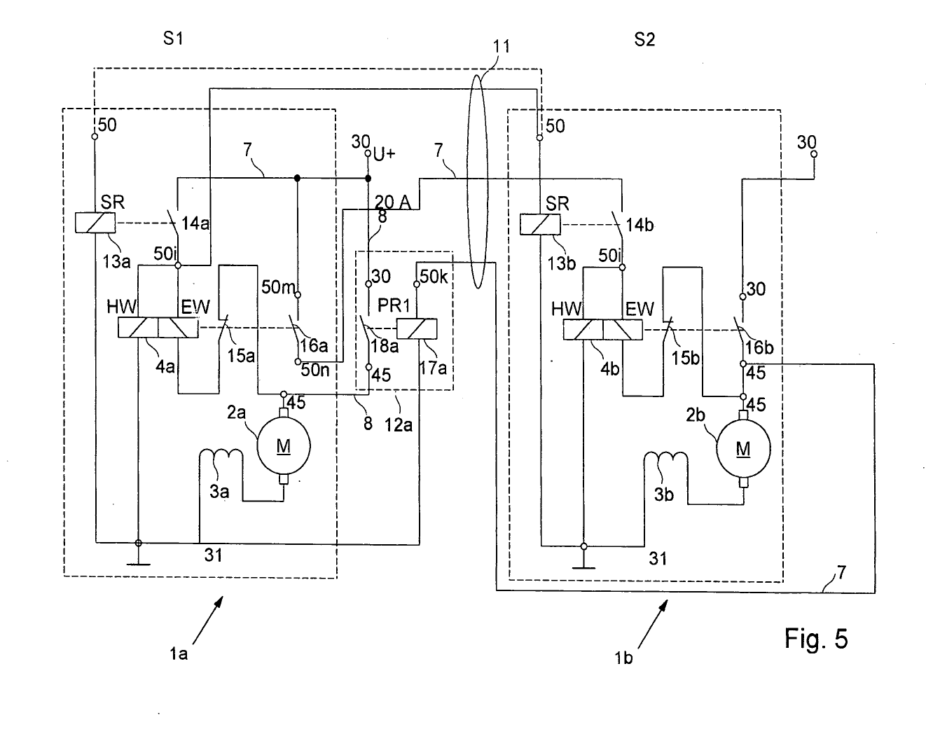

FIG. 5 shows a third embodiment of a parallel starting system having two starters 1a, 1b connected in parallel similar to FIG. 2. In this version, however, only first starter 1a has its own power relay 12a. In contrast to FIG. 2, the primary current of starter motor 2b is switched by combined engaging relay 4b. Engaging relay 4b in this case operates a switch 16b which is connected between terminal 30 and terminal 45 of starter motor 2b. When contact 16b is closed, current is supplied to control terminal 50k of power relay 17a. Contact 18a switches the current for motor 2a with a slight time delay with respect to 16b. This version has the advantage that only one power relay 4 is needed. However, a slight time delay results when starting motors 2a, 2b, since engaging relay 4b first switches on motor 2b and only after that supplies current to series-connected power relay 12a which then switches the primary current to motor 2a.

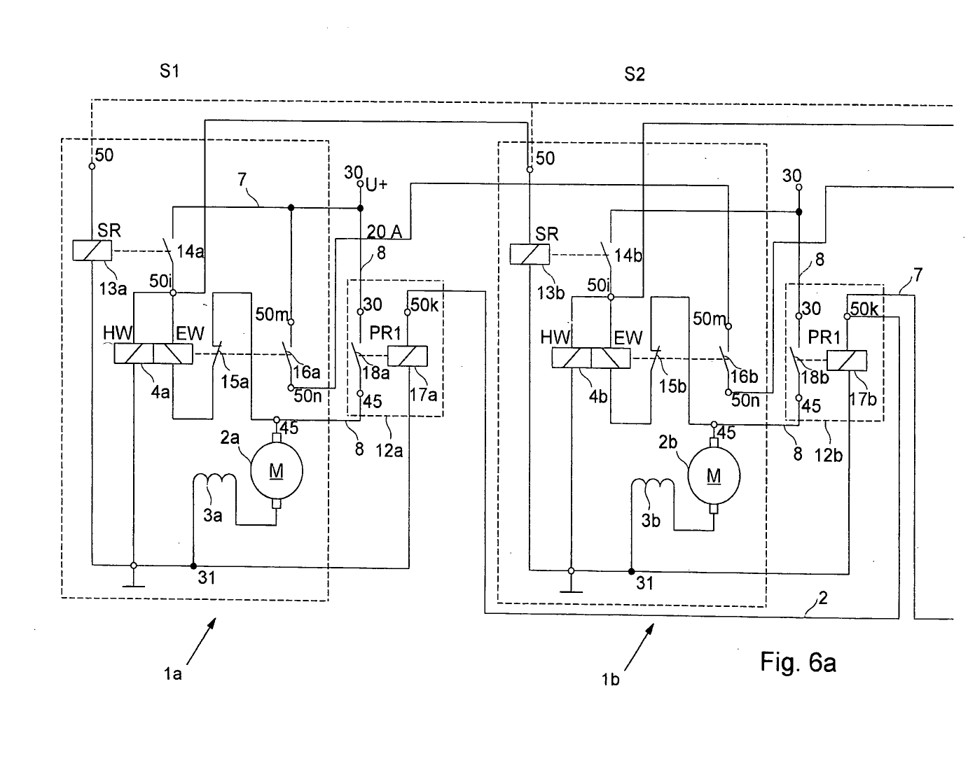

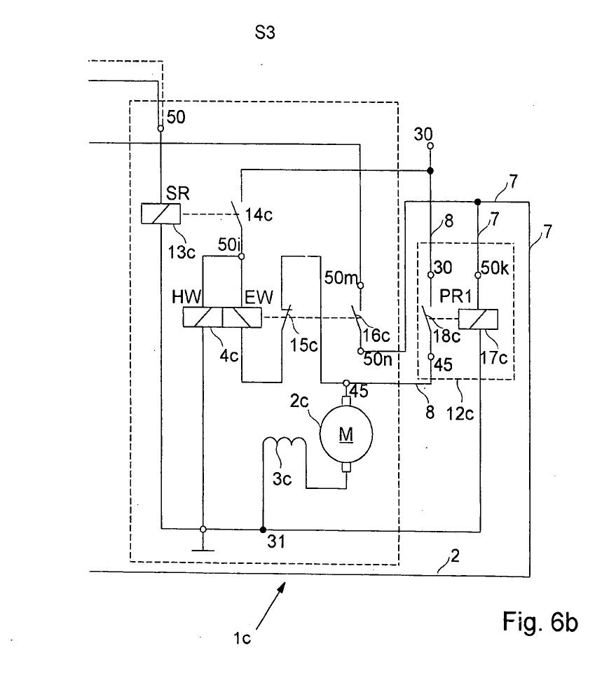

FIGS. 6a and 6b show a parallel connection of three starters 1a, 1b, and 1c. Optionally, even more starters 1 could be connected in parallel. The internal configuration of all starters 1 is identical. Only the external wiring is configured differently depending on the position of starter 1a, 1b, or 1c in the starter chain. In the case of a chain of n starters 1, all of the starters located in the middle are configured identically with regard to their external wiring. Only first and last starters 1a and 1n must be wired differently in this case. This may be implemented in a manner which is simple and cost-effective in particular.

### LIST OF REFERENCE NUMERALS

1 Starter
2 Starter motor
3 Series winding
4 Engaging relay
5 Load switch of engaging relay 4
6 Starter switch
7 Control lead
8 Primary current lead
9 Ground wire
11 Connecting leads
12 Power relay
13 Starting relay
14 Load switch of the starting relay
15 Normally closed contact of the engaging relay.
16 Normally open contact of the engaging relay
17 Winding of the power relay
18 Load switch of power relay 12

1-8. (canceled)

9. A starter system for starting an internal combustion engine, comprising:
a plurality of starters connected in parallel, each having a starter motor and an engaging relay,
wherein at least one of the starters has a power relay which switches a primary current path to the associated starter motor, and
wherein the engaging relay, the power relay, and the starter motor are configured as a structural unit.

10. The starter system according to claim 9, wherein the starters are interconnected in such a way that the starter motors are not fully supplied with current until all engaging relays have pulled up.

11. The starter system according to claim 9, wherein the engaging relays are connected in series and a load terminal of a last engaging relay is interconnected with a control terminal of one of the power relays.

12. The starter system according to claim 9, wherein the engaging relays of the starters are connected in parallel with regard to control terminals, and load terminals are connected in series, the load terminal of a last engaging relay being interconnected with the control terminal of one of the power relays.

13. The starter system according to claim 9, wherein each of the starters has a power relay, the power relays being connected in parallel and being connected in series to one of the engaging relays.

14. The starter system according to claim 9, wherein the engaging relays are connected in series, at least a last starter in a series having no power relay and the engaging relay of the last starter switching the primary current path to the starter motor.

15. The starter system according to claim 9, further comprising a three-pole electrical connection situated in each instance between two of the starters.

16. The starter system according to claim 9, further comprising a plug connection situated in each instance between two of the starters.
